(19) United States
(12) Patent Application Publication
(10) Pub. No.: US 2015/0129411 A1
(43) Pub. Date: May 14, 2015

(54) NON-ELECTRIC WATER DISTILLER

(71) Applicant: Glenn E. MEDER, Lincoln, NE (US)

(72) Inventor: Glenn E. Meder, Lincoln, NE (US)

(21) Appl. No.: 14/369,529

(22) PCT Filed: Mar. 22, 2013
(86) PCT No.: PCT/US2013/033573

§ 371 Date: Jun. 27, 2014

Related U.S. Application Data
(60) Provisional application No. 61/614,365, filed on Mar. 22, 2012.

(51) Int. Cl. B01D 3/02; C02F 1/04

(52) U.S. Cl. CPC B01D 3/02; C02F 1/04
USPC 202/190; 202/189

(57) ABSTRACT

In some embodiments, a distillation device having a first portion including a ringed area for resting on a boiling vessel is provided. A second portion is coupled to the first portion and a rest, coupled to the second portion and configured to receive a condensation surface above the second portion is provided. The second portion is configured to combine with a condensing surface to provide a condensation region the condensation region is configured to be in fluid communication with the boiling vessel.

### BACKGROUND

The present disclosure relates to batch distillation. In particular, the present disclosure relates to batch distillation for purification without the need for electric heating elements.

Distillation is a common method for the separation and purification of liquids. In particular, distillation may be used to provide a clean usable distillate, such as water. Clean, potable water is critical to health and in times of interrupted utility service, or in areas where potable water is not readily available, there is a need for portable and effective water purification.

Contaminated water can contain a variety of pathogens and toxins. Iodine tablets and boiling may be used to kill pathogens and even remove volatile organic compounds, but other toxins may be left behind. These include various solids, dissolved heavy metal salts, and non-volatile organic compounds that may be toxic.

Water distillation is often used to separate water from such contaminants. However, such stills are difficult to operate without entraining contaminants into the vapor stream that is then condensed to yield the potable water. When using an open flame, charcoal, wood stove, or the like, the heat applied to the feed water can be difficult to regulate. Thus, when more than the minimum amount of heat is added to the system, the feed may boil so vigorously that droplets with dissolved or entrained contaminants move with the water vapor and into the distillate. This defeats the purpose of the distillation and can compromise the safety of the water.

However, when utility service is interrupted (as may happen after a severe storm or natural disaster), or in areas with insufficient access to potable water (such as villages in third-world regions) easily regulated electric heating may not be an option. Accordingly, there is a need for a portable water distillation device that can be heated from a variety of sources and still yield safe, potable water.

### SUMMARY

A distillation device including a first portion having a ringed area for resting on a boiling vessel is disclosed. A second portion is coupled to the first portion, the second portion defining, in combination with the first portion, and intermediate region configured to be in fluid communication with the boiling vessel through a plurality of openings in the first portion. A rest, integral to the second portion and configured to receive a condensation surface above the second portion is also provided. The second portion is configured to combine with a condensing surface to provide a condensation region.

In some embodiments, a distillation device having a first portion including a ringed area for resting on a boiling vessel is provided. A second portion is coupled to the first portion and a rest, coupled to the second portion and configured to receive a condensation surface above the second portion is provided. The second portion is configured to combine with a condensing surface to provide a condensation region the condensation region is configured to be in fluid communication with the boiling vessel.

In some embodiments, the second portion may be configured to combine with a condensing surface to provide a condensation region the condensation region. The condensation region may be in fluid communication with the boiling vessel by a tube. This allows the condensation and collection vessels to be positioned away from the boiling vessel.

### BRIEF DESCRIPTION OF THE DRAWINGS

FIG. 1 is a side elevation view of a distillation system.

FIG. 2 is a side elevation cut away view of a distillation device.

FIG. 3 is a side elevation cut away view of a distillation device.

FIG. 4 is a side elevation cut away view of a distillation system.

FIG. 5 is a side elevation cut away, exploded view of a distillation system.

FIG. 6 is a side elevation cut away, exploded view of a distillation system.

FIG. 7 is a side elevation cut away view of a distillation system.

FIG. 8 is a side elevation cut away view of a distillation system.

FIG. 9 is a side elevation cut away view of a distillation system.

### DETAILED DESCRIPTION

A device that will allow people to make high-purity distilled water from virtually any water source, including unsafe water, brackish water, ocean water and water of unknown quality is disclosed. The device purifies water using the process of distillation. The device can use any of a wide variety of heat sources, including but not limited to a wood burning stove, an electric stove, a coal fire, or a propane stove, to boil water with the intent of generating, collecting, and cooling the steam into pure distilled water. In addition to distilling water, the device can distill any substance or solution that can be distilled.

The device can be used for emergency preparedness so that people can provide their families with the highest quality water when hurricanes or other disasters disable municipal water treatment systems. The Device can also be used to provide a long-term source of high-purity drinking water. The Device can also be used by people who want a long-term desalination system. The Device can also be used by people who are camping or hiking or for any other purpose in which they need or want to produce pure and/or safe water. In addition, the Device may be used to distill alcohol or other substance or solution that can be concentrated or purified using the distillation process.

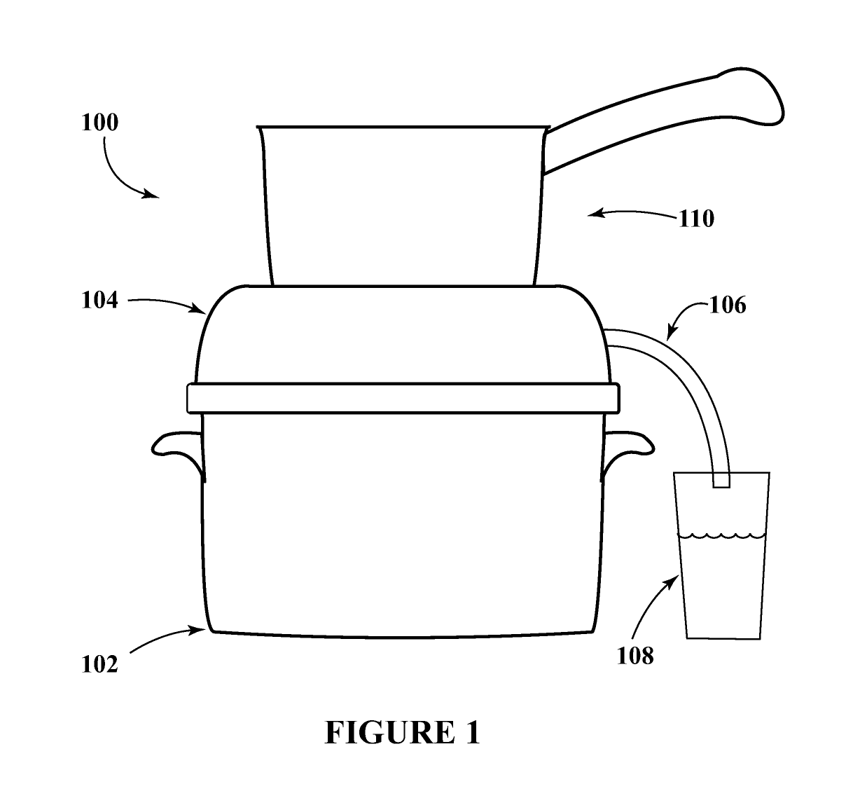

Referring to the Figures, FIG. 1 shows a system 100 including a vessel or chamber 102 (hereafter referred to as the Boiling Vessel) that is filled partway up with raw water is placed on a source of heat, such as a hotplate or a woodburning stove. A distillation device 104 is provided with a distillate tube 106 directed to a collection vessel 108. Cooling vessel 110 is provided and contains cool water to act as a heat sink and increase the rate of steam condensation.

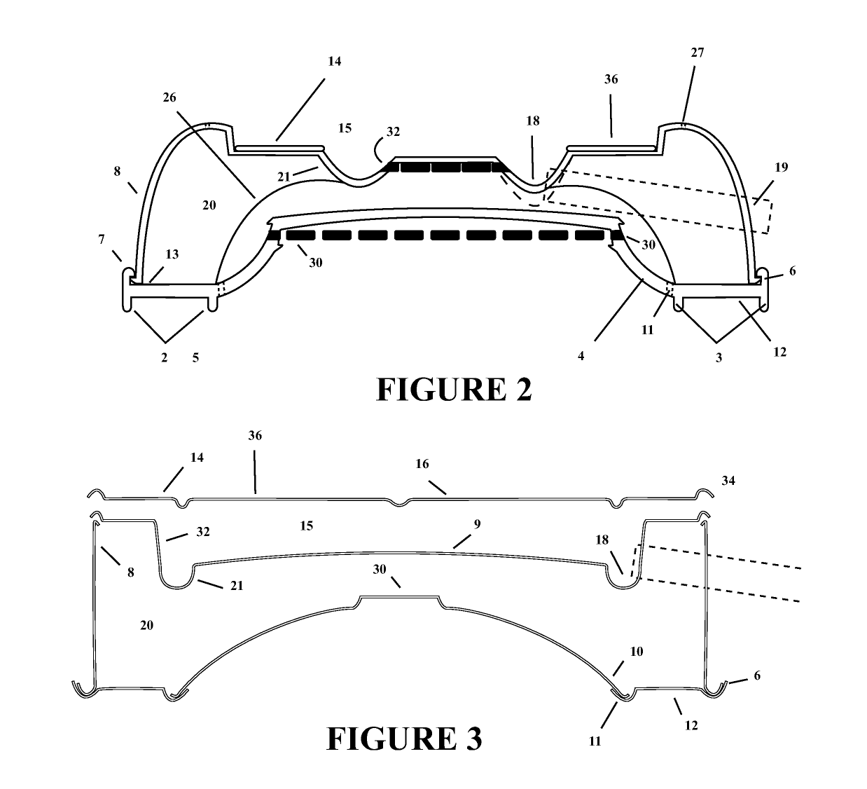

FIGS. 2 and 3 shows embodiments of a distillation device in more detail. The device, which may consist of different parts, such as but not limited to a top part (hereafter referred to as Part A) and a bottom part (hereafter referred to as Part B), one or more Auxiliary Baffles that may be incorporated into Part A and Part B or may be separate parts of the Device, a Distillate Tube and a Condensation Lid. The Device is placed on top of the Boiling Vessel. Another vessel (hereafter referred to as the Cooling Vessel) that contains water that will be used for cooling the steam back into liquid water is placed on top of the Device. The Device may be designed to be used with different sized cooking pots or other vessels that many people already have in their homes, or the Device could be designed to fit with specifically sized and/or configured Upper and Boiling Vessels.

In one or more configurations, the distillation device may incorporate a sturdy Ringed Area 12 that sits on top of the rim of the Boiling Vessel and/or in a possible configuration, the Collection Vessel, and provides the structural support for the Device and /or possibly the Cooling Vessel. This Ringed Area can be designed to fit a specific size and configuration of Boiling Vessel and/or Collection Vessel, and/or Cooling Vessel, or it can be made to fit various sized Vessels.

In one or more configurations, the distillation device may incorporate an inner and/or outer lower ridges 3 on underside of the Ringed Area 12, referred to as the Lower Ridges 3, which allow the User to use various sized Boiling Vessels, or in a possible configuration Collection Vessels, and/or which ensure that the Device stays properly positioned on the Boiling Vessel, and/or, which ensures that a minimum sized pot is used that ensures the overall stability of the Entire Assembly.

In one or more configurations, the distillation device may incorporate a raised angle on the inside of the Inner Ridge 4 of the Part B, referred to as the Steam Funnel so that steam would travel up to the Bottom Steam Holes 30 in a controlled manner, and to ensure that there is an adequate air gap between the Bottom Steam Holes 30 and the top of the boiling water. This angle also could provide structural strength to the Device and could prevent Boiling Vessels with a smaller diameter than the Ringed Area from being used.

In one or more configurations, the Ringed Area 12 may extend beyond the diameter of the Boiling Vessel and be exposed to higher temperatures or flame, thus the Ringed Area 12 may act as a heat and flame shield, and could protect Part A and the Steam Funnel from high heat and flame. For this reason, the design of the Ringed Area and the material that it's made from is crucial to the functionality of the Device. The Ringed Area may be made from material that has high temperature and flame resistance, such as metal or other materials.

In one or more configurations, the distillation device may incorporate an outside ridge 6 on the upper side of the Ringed Area that rises up (referred to as the Upper Ridge) which prevents water that accumulates on the top side of Part B from dripping out of the unit and creates a water-trap between Part A and Part B, which may be a steam seal. This Upper Ridge 6 can also form a lip that securely holds Part A and Part B together.

In one or more configurations, the distillation device may connect the Support Structure 8 of Part A to the sturdy Ringed Area 12 of Part B. The walls of Part A could rise up from the Ringed Area and provide structural strength to the Device.

In one or more configurations, Part A could be made in two or more pieces; the Support Structure 8 and the Distillate Channel Assembly 9, which would fit together and function together as Part A.

In one or more configurations, Part A could be made to affix to the side of different sizes and configurations of Cooling Vessels, or it could be made to affix to the side of a specific size and configuration of Cooling Vessel.

In one or more configurations, Part B could be made in two or more pieces; the Ringed Area 12 and the Steam Funnel 10, which would fit together and function as Part B. This design aspect could, among other designs functions, allow the Ringed Area to be constructed with high-temperature, flame-resistant material, such as metal, while the Steam Funnel could be made with less expensive material.

In one or more configurations, the distillation device may incorporate Drain Holes 11, that allow water that accumulates on the top side of Part B to drain back into the Boiling Vessel. These drain holes 11 may be positioned at a location that is lower than the Upper Ridge 6 and inside the Inner Ridge 4 so that the water would drain back into the Boiling Vessel instead of draining outside of the Device or collecting somewhere in the device. The shape of the drain holes 11 may be shaped in a slit or other shape so that accumulated water flows freely into the Boiling Vessel without the surface tension of the water causing the water to pool and not flow into the Boiling Vessel. In addition, the Drain Holes may be configured to be the size and shape that prevents splashes of Raw Water to splash up and potentially gain access to the Condensation Area .

In one or more configurations, the distillation device may incorporate a seal where the Ringed Area 12 connects with the Boiling Vessel, by means of a gasket, o-ring, a coated material or by creating a water seal or other means.

In one or more configurations, the distillation device may incorporate a seal where Part A and Part B connect. This seal may be created by the connecting fitting, a water seal, gasket, o-ring, a coated material or another means.

In one or more configurations, the distillation device may incorporate a recessed area 14 on the top of the Device, which could be part of Part A, and/or the Condensation Lid 16, referred to as the Cooling Vessel Seat 36, in which the Cooling Vessel can sit. This Cooling Vessel Seat 36 may be designed so that pots or vessels of different sizes and configurations can be used, or it can be designed to be used with a specific sized Cooling Vessel. This Cooling Vessel Seat may restrict the minimum and maximum diameter of the Cooling Vessel.

In one or more configurations, the distillation device may incorporate a ledge or raised elements in the Cooling Vessel Seat that supports the Cooling Vessel while creating an adequate air gap on the bottom of the Cooling Vessel that allows the steam to condense on the bottom or side surface of the Cooling Vessel, or on the bottom of the Condensation Lid while allowing the distilled water to drain away and out of the Device via the Distilled Water Channel. This Cooling Vessel Seat could prevent the steam from escaping to the air, even when different sized Cooling Vessels are used.

In one or more configurations, the distillation device may incorporate a Condensation Lid 16 on top of Part A that provides a conductive surface that would come in contact with the Cooling Vessel or other cooling mechanism. This Condensation Lid 16 could perform multiple functions including providing a level and stable platform for Cooling Vessels of different sizes to sit on, and also providing a closed environment for the steam so that the steam would condense on the Condensation Lid 16 instead of condensing directly on the bottom of the Cooling Vessel, thus reducing a potential contamination risk. Furthermore, the Condensation Lid could incorporate a lip 34 that directs spilled liquids, which could contain contaminants, to drip down the outside of the Device, and not into the Device where the dripped liquids could potentially contaminate the Distillate.

In one or more configurations, the distillation device may incorporate a configuration that limits the sizes of pot and vessels that may be used for the Cooling Vessel and Boiling Vessel, and may limit the size of the Cooling Vessel and Boiling Vessel in relation to each other. For example, the ratio of the Ringed Area 12 diameter compared to the size of the Cooling Vessel Seat may require the Boiling Vessel to be a wider diameter than the Cooling Vessel.

In one or more configurations, the distillation device may incorporate Distillate Channels 18, which comprise grooves and channels that allow condensed water to flow to designed low-point, where the distilled water is then drained out of the Device.

In one or more configurations, the distillation device may incorporate a Distillate Tube 19 fitted through the Device that allows the Distillate to drain out of the Device into a Collection Vessel.

In one or more configurations, Part A and Part B of the device may fit together in such a way as to create a space 20 between Part A and Part B of the Device, which creates an air gap, referred to as the Fixed Air Gap, and possibly multiple air gaps. This Fixed Air Gap 20, and the manner in which the Steam Holes and the position and angle of the Steam Holes, and the shapes of the Parts work together to create a Baffle that effectively separates and removes any splashes of contaminated water from the high-purity steam, with the goal of only allowing the high-purity steam to go into the Condensation Area 15. For example, the Bottom Steam Holes 30 could be positioned so that the steam would travel in a controlled manner so that it has to change direction multiple times before going through the Top Steam Holes 32 while any droplets of contaminated water that may have splashed up would not be able to proceed any further and would simply drain back into the Lower Vessel.

In one or more configurations, the Distillate Channels 21 may be shaped in such a way as to be an obstacle or shield, on the bottom side, that could prevent splashes of Raw Water from entering the Condensation Area 15. The shape of the Distillate Channel 21 could be an integral component of the Baffle, while also functioning to deliver the Distillate to the Distillate Tube 19.

In one or more configurations, Part B of the Device could be a lid that fits various sized pots, or a lid that fits a specific sized pot, or a connection that attaches to a variety of sizes and configurations of Boiling Vessels, such as a kettle, and Part B would connect to a Steam Tube that captures the steam and delivers the steam to Part A of the Device. Part B could also incorporate a handle and/or one or more Auxiliary Baffles, which could be incorporated into Part B, and/or the Steam Tube, and/or Part A. The Baffle(s) would create a barrier or obstacle to droplets and/or by creating an area in which the steam must change direction and flow in a way that liquid water is not able to follow.

In one or more configurations, the Device could be designed so that the parts and components of the Device could be assembled in various configurations, or alternatively, the Device could be designed to be used in specific configurations only. For example, in one of the possible configurations, the Device could be assembled in the Basic Configurations, and then many of the same components could be assembled in an Alternate Configuration.

In one or more configurations, Part A of the distillation device could attach or sit or otherwise be positioned below or to the side of the Cooling Vessel.

In one or more configurations, the distillation device may incorporate additional structural support by support braces 26.

In one or more configurations, the distillation device may incorporate one or more small holes 27, referred to as a VOC Vent Hole that could perform various purposes, including but not limited to allowing VOC gases to vent to the atmosphere and to ensure that the inside of the unit remains at atmospheric pressure.

In one or more configurations, the distillation device may replace the Cooling Vessel with an air-cooled section. In one or more configurations, the distillation device may sterilize water or other liquid in the Cooling Vessel by heating it with steam. In one or more configurations, the Device could be configured so that it could be operated with positive or negative air pressure inside the device in relation to the outside atmospheric pressure, which would affect the boiling point of the water and would affect the cooling effectiveness of the Cooling Vessel. In such a configuration, the system would be a sealed system and would be made of materials that will support such a vacuum. In such a configuration, the system could include a vacuum pump, a venture-vacuum, or some other system that would create either a vacuum or positive pressure inside the device. In one or more configurations, the Device could be used to distill alcohol or any other solution or substance that could be distilled.

The materials used to construct the Device may be durable materials that can handle high-temperatures without melting and warping and be suitable to be in contact with high-purity water and steam. The materials must also be able to handle high heat without contributing to further contamination. These can include, but are not limited to, such materials as stainless steel, certain plastics and silicone.

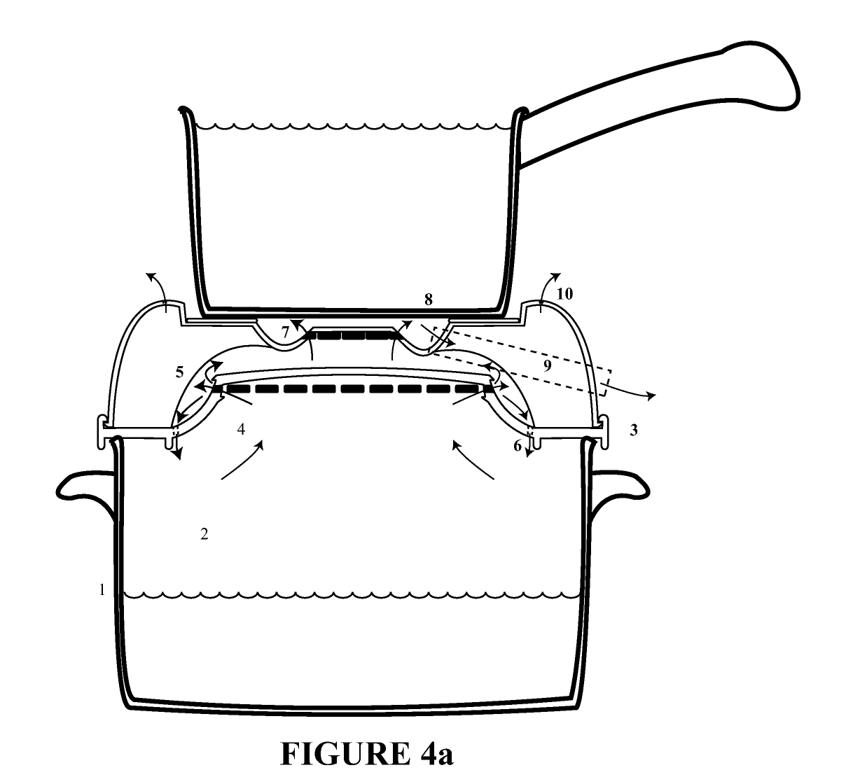

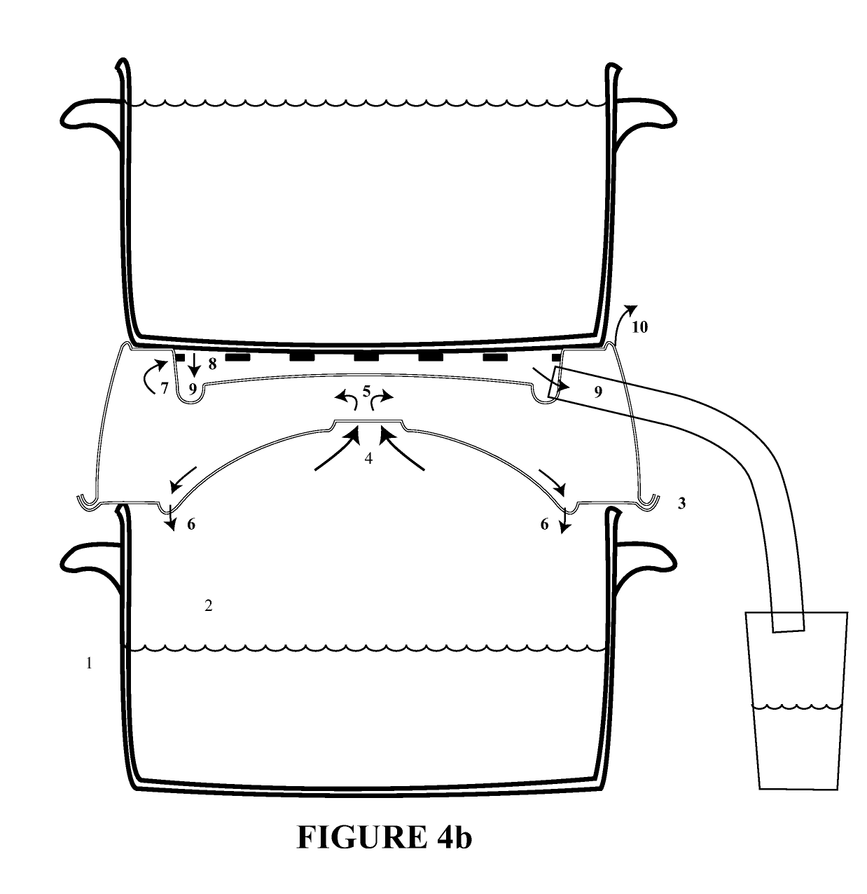

Referring to FIG. 4, the device of FIG. 2 is shown in use. The numbers on FIG. 4 correspond to the following steps of operation:
1) The Boiling Vessel is partially filled with Raw Water, and is then placed on a Heat Source. The Raw Water comes to a boil, which kills biological contaminants
2) The boiling action causes a phase change so that the liquid changes to vapor. (Contaminants that have a lower boiling point than water may be vented away. Contaminants with a higher boiling point than water will be left behind in the Boiling Vessel, to be discarded later.)
3) The Invention is placed on top of the Boiling Vessel.
4) The steam rises and is channeled through one or more holes in Part B (hereafter referred to as Bottom Steam Holes) that may have a particular shape and position in relation to one or more holes in Part A (hereafter referred to as the Top Steam Holes) for the purpose of separating any splashes of contaminated water from the high-purity steam.
5) The steam enters a Fixed Air Gap, which is the space between Part A and Part B and must change directions and rise in order to proceed through the Top Steam Holes.
6) Droplets of contaminated water that were splashed up during the boiling process are separated in the Fixed Air Gap and drip down and through the Drain Holes back into Boiling Vessel.
7) The steam travels through the Top Steam Holes to the Condensation Area, and then to the Condensation Surface.
8) The Cooling Vessel then removes the heat from the steam, and turns the steam into Distillate.
9) The Distillate drips down into Distillate Channel and out the Distillate Tube into a Collection Vessel.
10) One possible configuration of the system includes VOC Vent Holes which vent volatile gases away before they are condensed with the Distillate.

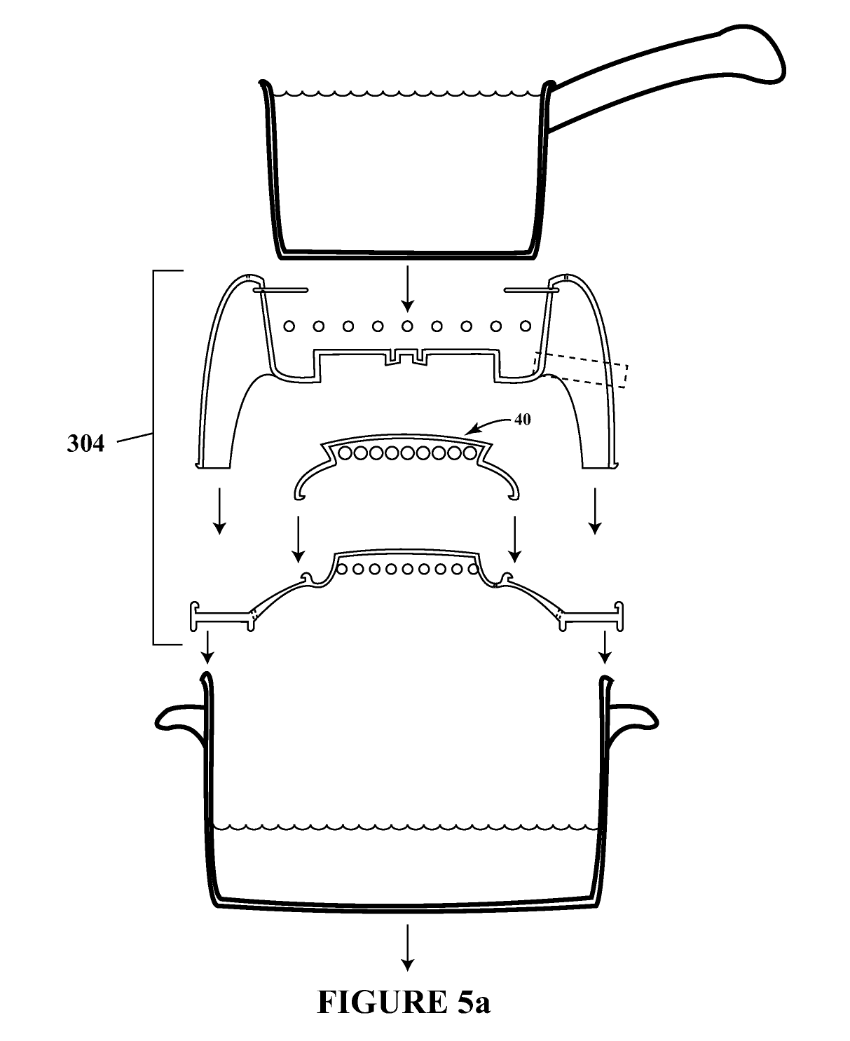

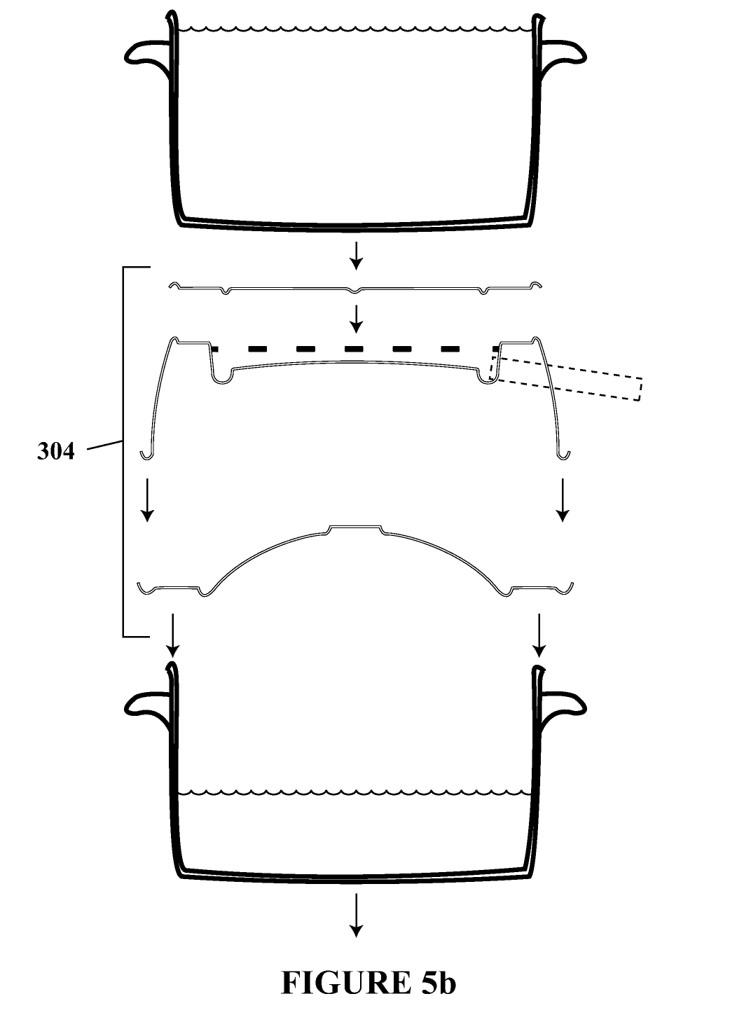

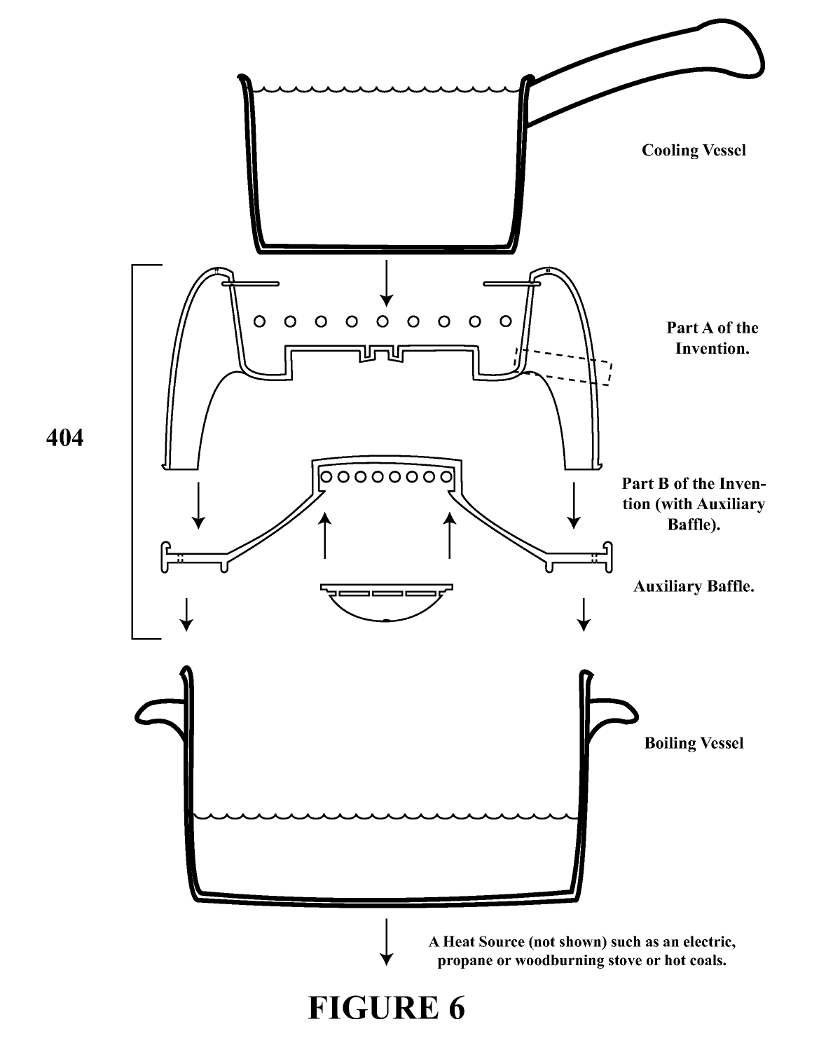

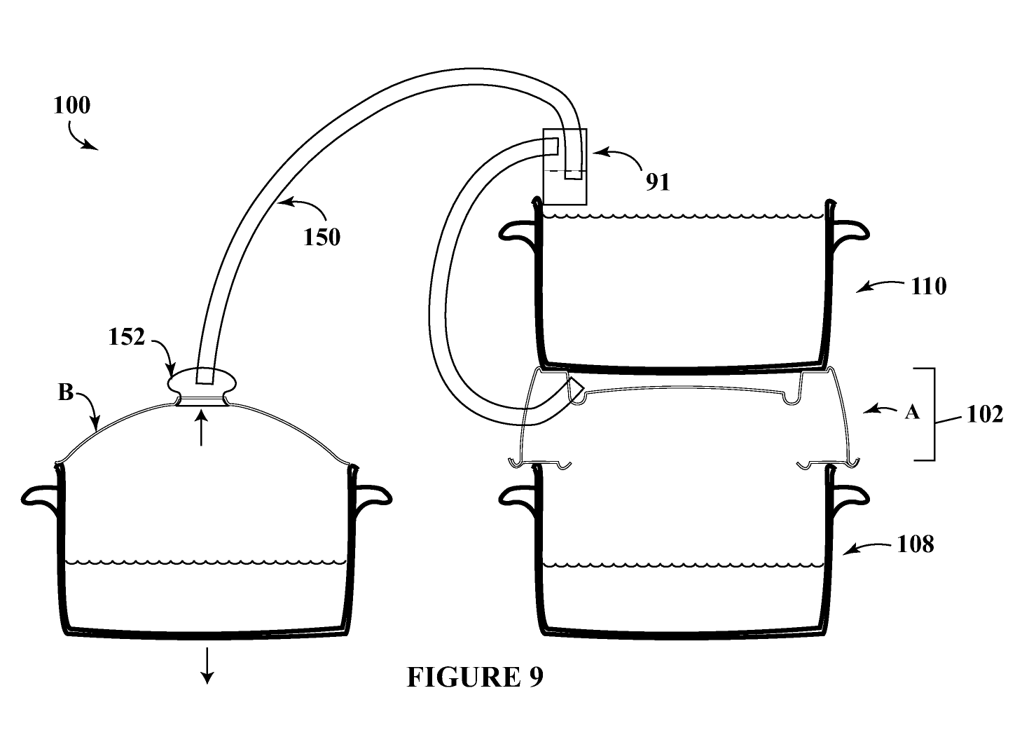

Referring to FIGS. 5 and 6, in one or more configurations, the distillation device may incorporate one or more additional Baffles, referred to as Auxiliary Baffles that may be used to further ensure the separation of steam from droplets of contaminated water that may splash up. These Auxiliary Baffle(s) would create a barrier or obstacle to droplets and/or by creating an area in which the steam must change direction and flow in a way that liquid water is not able to follow. These additional Auxiliary Baffles could be incorporated into Part B, and/or the Steam Tube, and/or the Boiling Vessel, and/or the Cooling Vessel and/or Part A. In FIG. 5, an Auxiliary Baffle 40 is positioned between Part A and Part B. In FIG. 6, an Auxiliary Baffle is positioned below Part B. In FIG. 9, an Auxiliary Baffle 91 is positioned on the cooling vessel, so that any droplets of water removed by the baffle would drip into the cooling water.

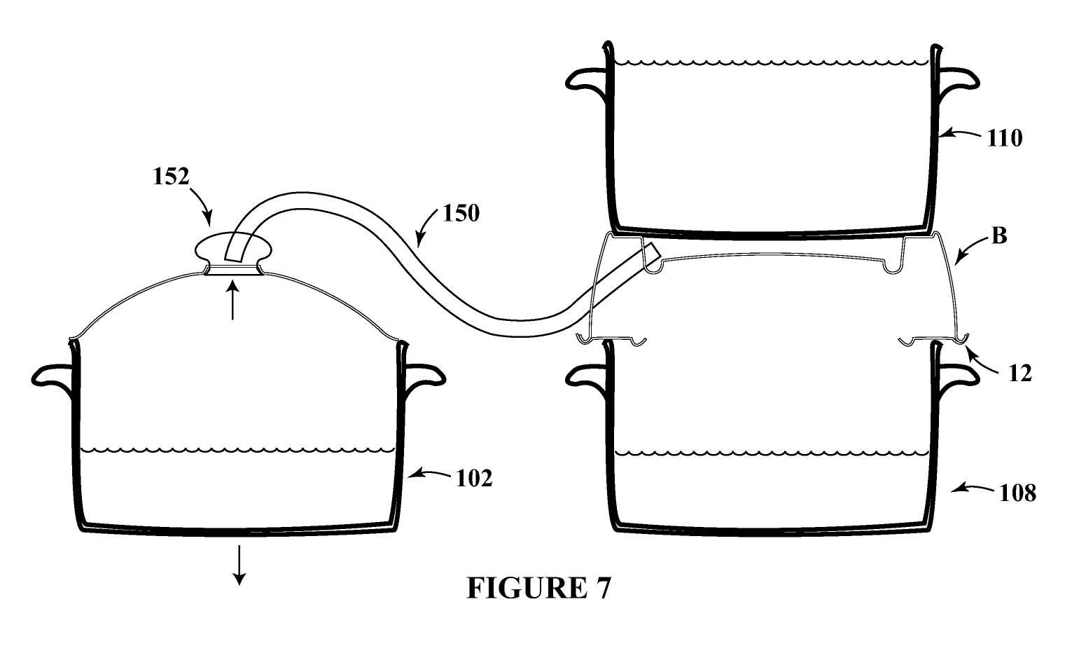

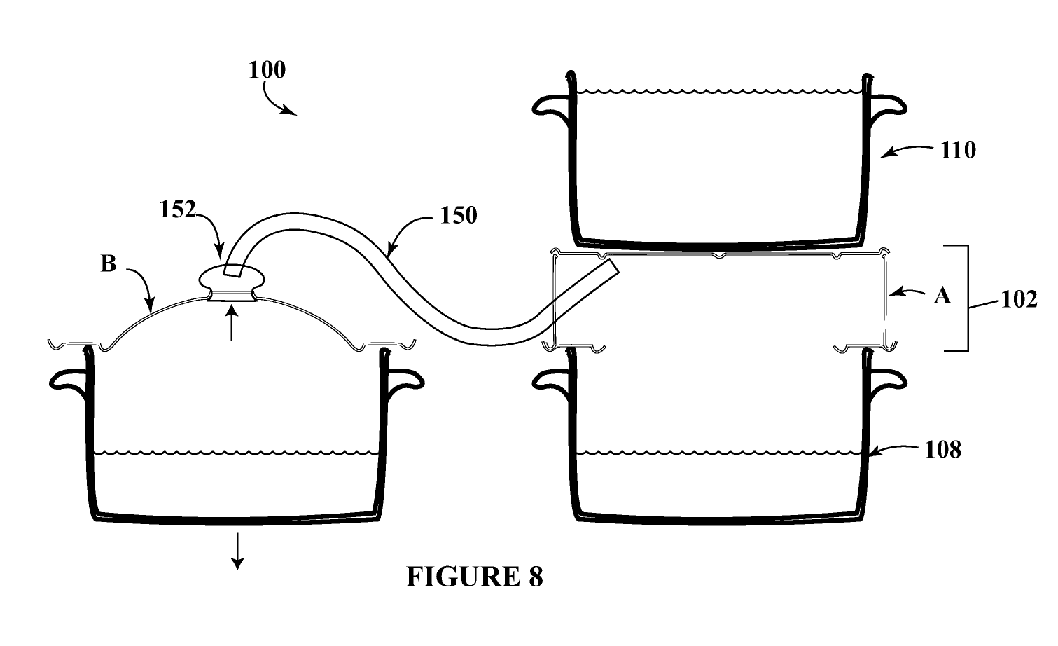

Referring to FIGS. 7 and 8, the Device 102 can also be configured as follows: a vessel or chamber or pot or kettle (the Boiling Vessel 102) is placed on a source of heat. In this configuration, Part B of the Device could act as a lid for various sized pots, or for a specific sized pot, or it could be a tube connection that could connect to a kettle or other steam generating source. Part B would capture steam from the Boiling Vessel and would channel the steam through a Steam Tube 150. Part B may also incorporate a Handle or Auxiliary Baffle 152 that would separate the high-purity steam from droplets of contaminated water that could splash up, by creating a barrier or obstacle to droplets and/or by creating an area in which the steam must change direction and flow in a way that liquid water is not able to follow. The Steam Tube 150 then would deliver the steam to Part A, which in this configuration, would sit below or would attach to the side of the Cooling Vessel 110. The Device 102 may be designed to be used with different sized cooking pots or other vessels that many people already have in their homes while remaining sturdy, or the Device 102 could be designed to fit with specific sized vessels. The Device 102 could be designed so that it can be assembled in only one configuration, or it could be designed so that it could be assembled in multiple configurations.

In operation, the device configured according to FIGS. 7 and 8 may operate as follows:
1) The Boiling Vessel is partially filled with Raw Water, and is then placed on a Heat Source. The Raw Water comes to a boil, which kills biological contaminants
2) The boiling action causes a phase change so that the liquid water changes to steam. (Contaminants that have a lower boiling point than water may be vented away. Contaminants with a higher boiling point than water will be left behind in the Boiling Vessel, to be discarded later.)
3) In this configuration, Part B of the Device could be a lid that fits various sized pots, or a lid that fits a specific sized pot, and this lid would have a Steam Tube that captures the steam. Part B could also be a fitting that connects a Steam Tube with a kettle or other steam capture device.
4) Steam would be captured by the Steam Tube and would travel to Part A of the Device.
5) One or more Baffles could be incorporated into Part B, and/or the Steam Tube, and/or Part A. The Baffle(s) would create a barrier or obstacle to droplets and/or by creating an area in which the steam must change direction and flow in a way that liquid water is not able to follow.
6) The high-purity steam would then flow into Part A, which would be below or to the side of the Cooling Vessel, and into the Condensation Area and onto the Condensation Surface, where the steam would convert into Distillate.
7) The Distillate would then drop down directly into the Collection Vessel, or onto the Distillate Channel and out the Distillate Tube into a Collection Vessel.

What is claimed is:

1. A distillation device comprising:
a first portion including a ringed area for resting on a boiling vessel;
a second portion, coupled to the first portion, the second portion defining, in combination with the first portion, an intermediate region configured to be in fluid communication with the boiling vessel through a plurality of openings in the first portion;
a rest, coupled to the second portion and configured to receive a condensation surface above the second portion, wherein the second portion is configured to combine with the condensing surface to provide a condensation region; and a baffle configured to obstruct the flow of entrained liquid either into or out of the intermediate region.

2. The distillation device of claim 1, wherein the second portion includes a top surface and a bottom surface, the top surface at least partially defining a distillate channel.

3. The distillation device of claim 2, wherein the second portion includes a baffle defined, at least in part, by a portion of the bottom surface corresponding to the distillate channel.

4. The distillation device of claim 1, wherein the condensation surface is the outer surface of a vessel of cool water.

5. The distillation device of claim 1, wherein the condensation surface is a lower surface of a condensation lid.

6. The distillation device of claim 1, wherein the intermediate region is of a fixed volume.

7. The distillation device of claim 1, wherein the ringed area is of sufficient diameter to allow the first portion to rest on vessels of a variety of sizes.

8. A distillation device comprising:
a first portion configured to at least partially enclose a boiling liquid;
a second portion, coupled to the first portion;
a rest, coupled to the second portion and configured to receive a condensation surface above the second portion, wherein the second portion is configured to combine with the condensing surface to provide a condensation region; and
wherein the condensation region is configured to be in fluid communication with the boiling vessel.

9. The distillation device of claim 8, wherein the second portion includes a top surface and a bottom surface, the top surface at least partially defining a distillate channel.

10. The distillation device of claim 9, wherein the second portion includes a baffle defined, at least in part, by a portion of the bottom surface corresponding to the distillate channel.

11. The distillation device of claim 8, wherein the condensation surface is the outer surface of a vessel of cool water.

12. The distillation device of claim 8, wherein the condensation surface is a lower surface of a condensation lid.

13. The distillation device of claim 8, wherein the ringed area is of sufficient diameter to allow the first portion to rest on vessels of a variety of sizes.

14. The distillation device of claim 8, wherein the condensation region is configured to be in fluid communication with the boiling vessel by way of a tube.

15. The distillation device of claim 8, wherein the intermediate region is of a fixed volume.

16. A distillation device comprising:
a first portion configured to at least partially enclose a boiling liquid;
a second portion, coupled to the first portion;
a rest, coupled to the second portion and configured to receive a condensation surface above the second portion, wherein the second portion is configured to combine with the condensing surface to provide a condensation region; and
wherein the condensation region is configured to be in fluid communication with the boiling vessel by way of a tube.

17. The distillation device of claim 16, wherein the second portion includes a baffle defined, at least in part, by a portion of the bottom surface corresponding to the distillate channel.

18. The distillation device of claim 16, wherein the condensation surface is the outer surface of a vessel of cool water.

19. The distillation device of claim 16, wherein the condensation surface is a lower surface of a condensation lid.

20. The distillation device of claim 16, wherein the second portion includes at least one vent opening.
